(19) United States
(12) Patent Application Publication
(10) Pub. No.: US 2009/0189876 A1
(43) Pub. Date: Jul. 30, 2009

(54) Control device for determining 4-wire or 5-wire resistive touch screen

(75) Inventors: Chang Yi Chen, Taipei (TW); Hung-Yi Lin, Taipei (TW); Sheng-Chun Chueh, Taipei (TW)

Correspondence Address: BACON & THOMAS, PLLC, 625 SLATERS LANE, FOURTH FLOOR, ALEXANDRIA, VA, 22314-1176, US

(73) Assignee: IdeaCom Technology Inc., Shindian City (TW)

(21) Appl. No.: 12/153,549

(22) Filed: May 21, 2008

(30) Foreign Application Priority Data
Jan. 29, 2008 (TW) 097103400

(51) Int. Cl. G06F 3/045

(52) U.S. Cl. 345/174

(57) ABSTRACT

The present invention provides A control device for determining 4-wire or 5-wire resistive touch screen, comprising: detecting means for respectively sending 4-wire control instruction and 5-wire control instruction in the period before sending control instructions of fetching X-axis and Y-axis coordinate position, so as to detect whether a 4-wire resistive touch screen or 5-wire resistive touch screen are being attached; control means, in accordance with the detected result of the detecting means, the control device is switched to 4-wire or 5-wire resistive touch screen so as to fetch the coordinate position.

### FIELD OF THE INVENTION

This invention relates to a control device for determining 4-wire or 5-wire resistive touch screen, so as to automatically run the driver program of 4-wire or 5-wire resistive touch screen to control the 4-wire or 5 wire resistive touch screen.

### BACKGROUND OF THE INVENTION

A touch screen is widely used in digital device systems such as a ticket system, a hand writing recognition system, a game system, a multiple-screen system, that require selecting the desired items or inputting words by means of screen. The working theory is as follows. The analog signal generated from voltage drop is transformed to digital signal. The digital signal is thus received to determine the coordinate position that a user touches the screen. The touch screens are mainly classified as a resistive touch screen, a capacitor touch screen, an optical touch screen, and an acoustic wave touch screen, wherein the resistive touch screen is the most popular one among them based on the reason of its stability.

In FIG. 4, it is a resistive touch screen, where a voltage of 3 Volt to 5 Volt is applied between ITO (Indium Tin Oxide) film 41 and ITO conductive glass 42, and spacer dots 43 are arranged therebetween. When ITO film 41 is pressed to touch ITO conductive glass 42, the driving voltages are respectively dropped in respective X-axis and Y-axis. The voltage drop which is an analog signal is transformed by a A/D converter (not shown) to a digital signal. The digital signal is then calculated by driver program to determine which coordinate position that a user is pressed.

The resistive touch screen is mainly classified as 4-wire resistive touch screen and 5-wire resistive touch screen. An example of 4-wire resistive touch screen (herein after referred to 4-wire screen) is found in FIG. 5, where the driving voltages for X-axis and Y-axis are applied in a conductive bar 51 to set driving voltage in every side of ITO film 41 and ITO conductive glass 42. However, since when ITO film 41 is repeatedly pressed in a long period, it will easily damage its surface, thus sometimes the wiring is disconnected to cause malfunction of device. Thus an improved device called 5-wire resistive touch screen (herein after referred to 5-wire screen) were introduced.

In FIG. 6, a 5-wire screen is shown, where the four corners 61 of ITO conductive glass 42 are applied with driving voltages in X-axis and Y-axis, and ITO film 41 is only used as conductive material. A wiper signal (WIPER) is used to measure the voltage drop when the screen is touched, and the A/D converter calculates the coordinate position based on the WIPER signal. Thereafter, when ITO film 41 is scratched, less malfunction happens. Both in FIG. 5 and FIG. 6, elements 52 and 62 represent dielectric material such as glass.

Since 4-wire screen and 5-wire screen are both widely used, a control device for determining the two screen to control the screen connected is desired.

### SUMMARY OF THE INVENTION

The present invention provides a control device for determining 4-wire or 5-wire resistive touch screen, comprising: detecting means for respectively sending 4-wire control instruction and 5-wire control instruction in the period before sending control instructions of fetching X-axis and Y-axis coordinate position, so as to detect whether a 4-wire resistive touch screen or 5-wire resistive touch screen are being attached; control means, in accordance with the detected result of the detecting means, the control device is switched to 4-wire or 5-wire resistive touch screen so as to fetch the coordinate position.

The present invention also provides a control device for determining 4-wire or 5-wire resistive touch screen, wherein the pins of X+, X−, Y+, Y− and VBAT which are for 4-wire resistive touch screen are provided to respectively share the pins of UL, LL, UR, LR and WIPER which are for 5-wire resistive touch screen, and the WIPER pin is active only when 5-wire control instruction is sent.

The present invention also provides a control device, wherein the control means switches the control to control program for 4-wire resistive touch screen in the circumstance that the detecting means sends a 4-wire control instruction and an analog-to-digital converter receives numeral data and then the detecting means sends a 5-wire control instruction but the analog-to-digital converter does not receive numeral data. And the control means switches the control to control program for 5-wire resistive touch screen in the circumstance that the detecting means sends a 4-wire control instruction but a analog-to-digital converter does not receive numeral data, and then the detecting means sends a 5-wire control instruction and the analog-to-digital converter receives numeral data.

### BRIEF DESCRIPTION OF THE DRAWINGS

FIG. 1 is a drawing to show a pin diagram of a control device for determining 4-wire or 5-wire resistive touch screen of the present invention.

FIG. 2 shows an instruction timing diagram of the present invention, that is used for a control device to determine 4-wire or 5-wire resistive touch screen and detect a single position thereof.

FIG. 3a shows the detecting processes of the present invention when 4-wire screen is in use.

FIG. 3b shows the detecting processes of the present invention when 5-wire screen is in use.

FIG. 4 is a perspective view to show a resistive touch screen being pressed.

FIG. 5 is a constructing view of a 4-wire resistive touch screen.

FIG. 6 is a constructing view of a 5-wire resistive touch screen.

FIG. 7 is a conventional timing chart of control instruction for the resistive touch screen.

### DETAILED DESCRIPTION OF THE INVENTION

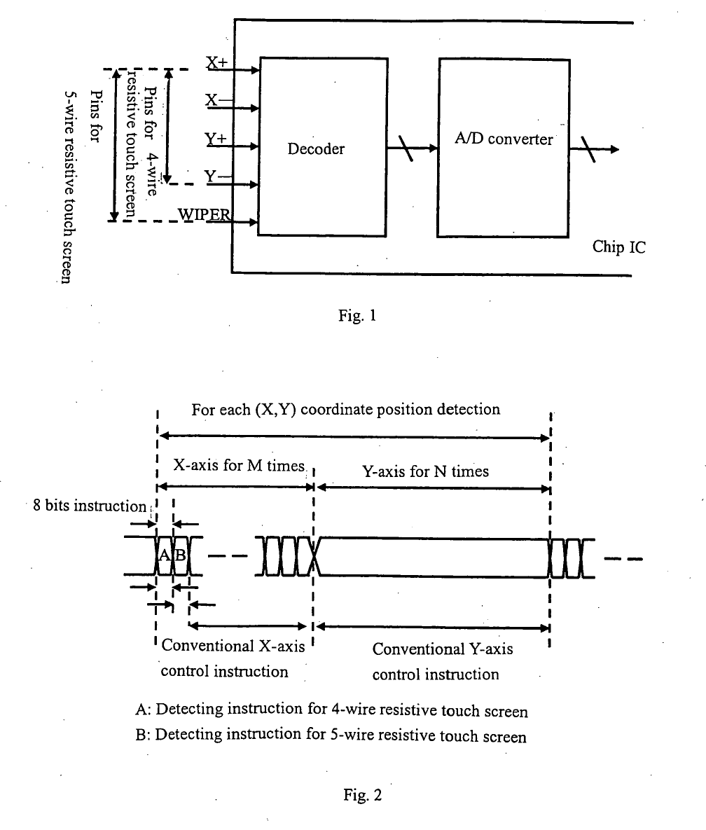

FIG. 1 is a drawing to show a pin diagram of a control device for determining 4-wire or 5-wire resistive touch screen of the present invention.

FIG. 7 is a conventional timing chart of a control instruction for the resistive touch screen. Every single instruction is composed of 8 bits so as to form one instruction selected from 4 wire mode, 5 wire mode, power-saving mode, and differential mode for a touch screen.

In FIG. 2, it shows timing diagram for instructions of a control device in order to determine 4-wire or 5-wire resistive touch screen and detect a single position of the present invention. Firstly, touch screen is triggered which enables a PENIRQ pin. Before the instructions of fetching X-axis data for M times and Y-axis data for N times in sequence, a 4-wire detecting instruction (A) and 5-wire detecting instruction (B) are sent in two time periods. In other words, there are two detecting instructions ((A) and B) sent by the control device to the attached touch screen so as to determine whether a 4-wire screen or 5-wire screen are being attached.

In FIG. 1, the control device of the present invention provides 4-wire screen's pins including X+, X−, Y+, Y− (where these four pins are active when 4-wire screen is being attached) and VBAT to respectively share the 5-wire screen's pins including UL, LL, UR, LR (where these four pins are active when 5-wire screen is being attached) and WIPER. When 4-wire screen is in use, pins of X+, X−, Y+, Y− are active. When 5-wire screen is in use, pins of UL, LL, UR, LR are active. Only when control instruction sent from the control device is for 5-wire screen, the pin of WIPER is active so as to receive the trigger signal from the control device. Otherwise, the pin of WIPER is disabled. The following processes of determination and control can be achieved by means of firmware or hardware architecture. In a preferred embodiment, the processes are implemented in form of firmware and stored in a chip.

(1) When a 4-Wire Screen is in Use:

(1a) As shown in FIG. 2, a 4-wire detecting instruction (A) is sent from the control device to the attached touch screen, and then the pins of X+, X−, Y+, Y− are active, whereas the pin of VBAT (i.e., WIPER) is disabled (the pin is active only when 5-wire control instruction is sent so as to receive 5-wire trigger signal). Since the pins of X+, X−, Y+, Y− are active, the voltage drop delivered by the 4-wire screen is received and transformed by an A/D converter to a digital signal. In other words, a numeral value is received.

(1b) In sequence, a 5-wire detecting instruction (B) is sent. In spite that the pins of X+, X−, Y+, Y−, WIPER are active, since a 4-wire screen is in use, the screen does not support the output signal of WIPER. Therefore, there is not signal received by the control device.

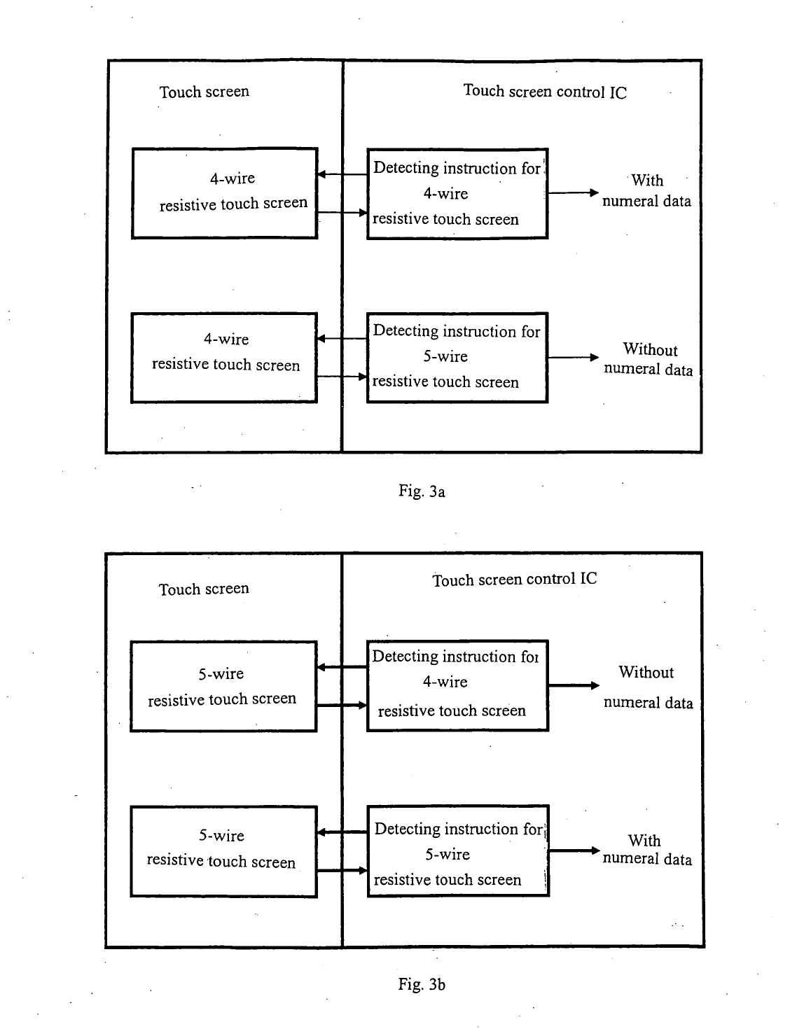

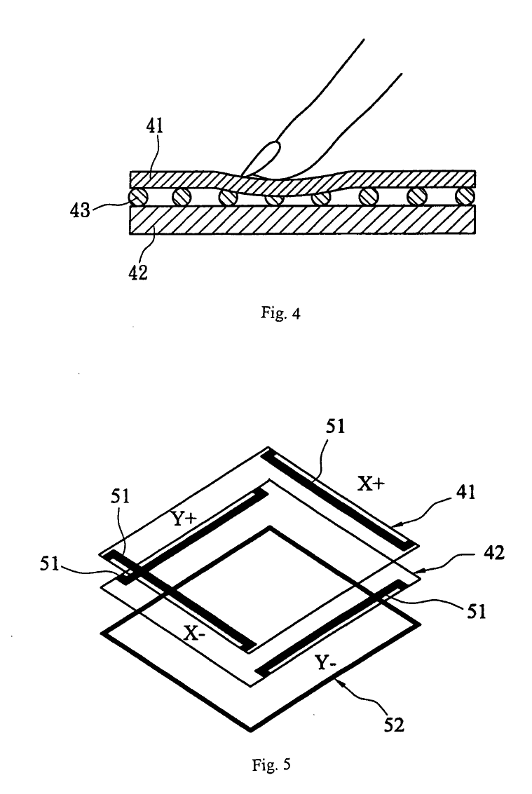

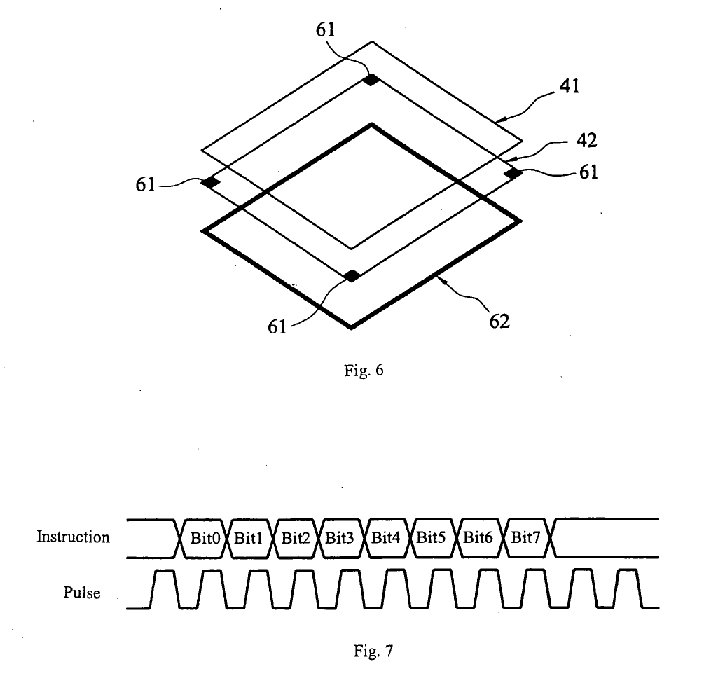

After the processes of (1a) and (1b), the control device determines that there is a 4-wire screen in use, based on the reason that after a 4-wire detecting instruction sent, a numeral signal received, but after a 5-wire detecting instruction sent, a numeral signal is not received. Thus, the control devices is switched to 4-wire driving program to control the 4-wire screen, as shown in FIG. 3a.

(2) When a 5-Wire Screen is in Use:

(2a) As shown in FIG. 2, a 4-wire detecting instruction (A) is sent from the control device to the attached touch screen, and then the pins of X+, X−, Y+, Y− are active, whereas the pin of VBAT (i.e., WIPER) is disabled (the WIPER pin is active only when 5-wire control instruction is sent so as to receive 5-wire trigger signal). Since the pin of WIPER is disabled and a 5-wire screen is in use, the control device does not receive any numeral signal.

(2b) In sequence, a 5-wire detecting instruction (B) is sent. Then all the pins of X+, X−, Y+, Y−, WIPER are active and a 5-wire screen is in use, so the voltage drop in WIPER pin is transferred to and transformed by an A/D converter to a digital signal. In other words, a numeral signal is received.

After the processes of (2a) and (2b), the control device determines that there is a 5-wire screen in use, based on the reason that after a 4-wire detecting instruction sent, a numeral signal is not received, but after a 5-wire detecting instruction sent, a numeral signal is received. Thus, the control device is switched to 5-wire driving program to control the 5-wire screen, as shown in FIG. 3b.

It should be understood by those skilled in the art that various modifications, combinations, sub-combinations and alternations may occur depending on design requirements and other factors insofar as they are within the scope of the appended claims or the equivalents thereof.

1. A control device for determining 4-wire or 5-wire resistive touch screen, comprising:
detecting means for respectively sending 4-wire control instruction and 5-wire control instruction in the period before sending control instructions of fetching X-axis and Y-axis coordinate position, so as to detect whether a 4-wire resistive touch screen or 5-wire resistive touch screen are being attached;
control means, in accordance with the detected result of the detecting means, the control device is switched to 4-wire or 5-wire resistive touch screen so as to fetch the coordinate position.

2. A control device as claimed in claim 1, wherein the pins of X+, X−, Y+, Y− and VBAT which are for 4-wire resistive touch screen are provided to respectively share the pins of UL, LL, UR, LR and WIPER which are for 5-wire resistive touch screen, and the WIPER pin is active only when 5-wire control instruction is sent.

3. A control device as claimed in claim 1, wherein the control means switches the control to control program for 4-wire resistive touch screen in the circumstance that the detecting means sends a 4-wire control instruction and an analog-to-digital converter receives numeral data and then the detecting means sends a 5-wire control instruction but the analog-to-digital converter does not receive numeral data.

4. A control device as claimed in claim 2, wherein the control means switches the control to control program for 4-wire resistive touch screen in the circumstance that the detecting means sends a 4-wire control instruction and an analog-to-digital converter receives numeral data and then the detecting means sends a 5-wire control instruction but the analog-to-digital converter does not receive numeral data.

5. A control device as claimed in claim 1, wherein the control means switches the control to control program for 5-wire resistive touch screen in the circumstance that the detecting means sends a 4-wire control instruction but a analog-to-digital converter does not receive numeral data, and then the detecting means sends a 5-wire control instruction and the analog-to-digital converter receives numeral data.

6. A control device as claimed in claim 2, wherein the control means switches the control to control program for 5-wire resistive touch screen in the circumstance that the detecting means sends a 4-wire control instruction but a analog-to-digital converter does not receive numeral data, and then the detecting means sends a 5-wire control instruction and the analog-to-digital converter receives numeral data.

7. A control device as claimed in claim 1, wherein the detecting means and the control means are implemented in form of firmware or hardware.

8. A control device as claimed in claim 2, wherein the detecting means and the control means are implemented in form of firmware or hardware.

9. A control device as claimed in claim 3, wherein the detecting means and the control means are implemented in form of firmware or hardware.

10. A control device as claimed in claim 4, wherein the detecting means and the control means are implemented in form of firmware or hardware.

11. A control device as claimed in claim 5, wherein the detecting means and the control means are implemented in form of firmware or hardware.

12. A control device as claimed in claim 6, wherein the detecting means and the control means are implemented in form of firmware or hardware.
